(19) United States
(12) Patent Application Publication
(10) Pub. No.: US 2025/0183685 A1
(43) Pub. Date: Jun. 5, 2025

(54) CHARGING CABLE

(71) Applicant: LUXSHARE PRECISION INDUSTRY COMPANY LIMITED, SHENZHEN (CN)

(72) Inventors: DaHong ZHANG, SHENZHEN (CN); ZhiYong LI, SHENZHEN (CN)

(73) Assignee: LUXSHARE PRECISION INDUSTRY COMPANY LIMITED, SHENZHEN (CN)

(21) Appl. No.: 18/820,671

(22) Filed: Aug. 30, 2024

(30) Foreign Application Priority Data
Dec. 1, 2023 (CN) 202311647017.1

(51) Int. Cl. H02J 7/00; G05F 1/575

(52) U.S. Cl. CPC H02J 7/0034; G05F 1/575; H02J 7/0042

(57) ABSTRACT

Disclosed is a charging cable including a power supply interface, a power receiving interface, a power transfer control circuit, an operational amplifier comparator circuit and a switch circuit for connecting or disconnecting a power pin of the power supply interface and a power pin of the power receiving interface. After the power transfer control circuit successfully handshakes with a charging device and/or a voltage of the power pin of the power receiving interface is less than or equal to a preset voltage of the power pin of the power supply interface, the switch circuit is turned on. After a divided voltage of the power pin of the power receiving interface is greater than a reference voltage and/or the voltage of the power pin of the power receiving interface is greater than the preset voltage of the power pin of the power supply interface, the switch circuit is turned off.

### CROSS REFERENCE TO RELATED PRESENT DISCLOSURE

This application claims the priority benefit of Chinese Patent Application Serial Number 202311647017.1, filed on Dec. 1, 2023, the full disclosure of which is incorporated herein by reference.

### Technical Field

The present disclosure relates to the field of charging technology, in particular to a charging cable.

### Related Art

With the rapid development of science and technology, people's demands for terminal devices are increasing, which makes charging devices and peripheral accessories thereof used to supply power to the terminal devices become important developments.

In the prior art, a charging device supplies power to a terminal device through a charging cable, wherein the power pins of the interfaces on both sides of the charging cable are directly connected. If the user accidentally uses the charging cable in reverse, the voltage at a power receiving end of the charging cable flows back to a power supply end of the charging cable. If the voltage at the power receiving end of the charging cable exceeds a preset voltage at the power supply end of the charging cable, the charging device connected to the power supply end will be damaged.

Therefore, how to provide a charging cable with an anti-backflow protection function is currently a problem that those skilled in the art need to solve.

### SUMMARY

The embodiment of the present disclosure provides a charging cable, which can solve the problem in the prior art that the charging device connected to the power supply end of the charging cable is damaged when the charging cable is used in reverse since the power pins of the interfaces on both sides of the charging cable are directly connected.

In order to solve the above technical problems, the present disclosure is implemented as follows:

The present disclosure provides a charging cable, which includes a power supply interface, a power receiving interface, a power transfer control circuit, an operational amplifier comparator circuit and a switch circuit. The power supply interface is selectively connected to a charging device, the power receiving interface is selectively connected to a DC power consumption device, the power transfer control circuit is connected to the power supply interface and the power receiving interface, the operational amplifier comparator circuit is connected to a power pin of the power receiving interface and the switch circuit, and the switch circuit is connected to the power transfer control circuit, the operational amplifier comparator circuit, a power pin of the power supply interface and the power pin of the power receiving interface. The power transfer control circuit is configured to establish a handshake connection with the charging device when the power supply interface is connected to the charging device and the power receiving interface is connected to the DC power consumption device and monitor a voltage of the power pin of the power receiving interface. The operational amplifier comparator circuit is configured to compare a divided voltage of the power pin of the power receiving interface with a reference voltage when the power supply interface is connected to the charging device and the power receiving interface is connected to the DC power consumption device. After the power transfer control circuit successfully handshakes with the charging device and/or determines that the voltage of the power pin of the power receiving interface is less than or equal to a preset voltage of the power pin of the power supply interface, the switch circuit is turned on to connect the power pin of the power supply interface to the power pin of the power receiving interface. After the operational amplifier comparator circuit determines that the divided voltage of the power pin of the power receiving interface is greater than the reference voltage and/or the power transfer control circuit determines that the voltage of the power pin of the power receiving interface is greater than the preset voltage of the power pin of the power supply interface, the switch circuit is turned off to disconnect the power pin of the power supply interface from the power pin of the power receiving interface.

In the charging cable of the embodiment of the present disclosure, when the power supply interface is connected to the charging device and the power receiving interface is connected to the DC power consumption device, if the power pin of the power receiving interface is suddenly applied with a voltage higher than the preset voltage of the power pin of the power supply interface, the operational amplifier comparator circuit determines that the divided voltage of the power pin of the power receiving interface is greater than the reference voltage, the power transfer control circuit determines that the voltage of the power pin of the power receiving interface is greater than the preset voltage of the power pin of the power supply interface, and the switch circuit is turned off, so that the power pin of the power supply interface is disconnected from the power pin of the power receiving interface, and the anti-backflow protection function is realized. The operational amplifier comparator circuit can respond quickly within nanoseconds and turn off the switch circuit quickly, so the protection time of the operational amplifier comparator circuit is at a nanosecond level. However, due to timing issues, the protection time of the power transmission control circuit lags slightly behind that of the operational amplifier comparator circuit, and the protection time of the power transmission control circuit is at a millisecond level. Therefore, when the power pin of the power receiving interface of the charging cable of the embodiment of the present disclosure is suddenly applied with the voltage higher than the preset voltage of the power pin of the power supply interface, the operational amplifier comparator circuit turns off the switch circuit first, and then the power transfer control circuit turns off the switch circuit to enhance the protection, thereby achieving a double protection effect.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a block diagram of a charging cable according to an embodiment of the present disclosure; and

FIG. 2 is a schematic structural diagram of a charging cable according to an embodiment of the present disclosure.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

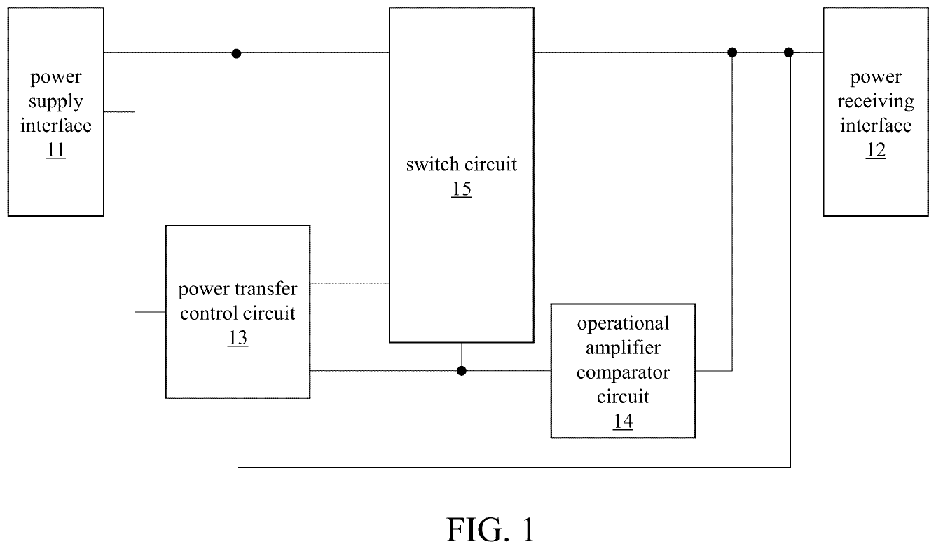

Please refer to FIG. 1, which is a block diagram of a charging cable according to an embodiment of the present disclosure. As shown in FIG. 1, a charging cable 1 comprises a power supply interface 11, a power receiving interface 12, a power transfer control circuit 13, an operational amplifier comparator circuit 14 and a switch circuit 15. The power supply interface 11 is configured to selectively connect to a charging device (not drawn), and the power receiving interface 12 is configured to selectively connect to a DC power consumption device (not drawn). The power supply interface 11 may be, but not limited to, a USB Type-C interface, the USB Type-C interface may comprise a power pin Vbus and a configuration channel pin CC, and the USB Type-C interface may be a USB Type-C male connector or a USB Type-C female connector. The power receiving interface 12 may be, but not limited to, a DC connector, the DC connector may comprise a power pin Vout (i.e., a positive terminal of the DC connector), and the DC connector may be a DC male connector or a DC female connector.

In this embodiment, the power transfer control circuit 13 is connected to the power supply interface 11 and the power receiving interface 12, the operational amplifier comparator circuit 14 is connected to the power pin of the power receiving interface 12 and the switch circuit 15, and the switch circuit 15 is connected to the power transfer control circuit 13, the operational amplifier comparator circuit 14, the power pin Vbus of the power supply interface 11 and the power pin Vout of the power receiving interface 12. The preset voltage of the power pin Vbus of the power supply interface 11 may be, but not limited to, 20 volts. In other words, the charging device provides preset power at 20V to the DC power consumption device through the charging cable 1.

When the power supply interface 11 is connected to the charging device and the power receiving interface 12 is connected to the DC power consumption device, the power transfer control circuit 13 is configured to establish a handshake connection with the charging device and monitor a voltage of the power pin Vout of the power receiving interface 12; the operational amplifier comparator circuit 14 is configured to compare a divided voltage of the power pin Vout of the power receiving interface 12 with a reference voltage. After the power transfer control circuit 13 successfully handshakes with the charging device and/or determines that the voltage of the power pin Vout of the power receiving interface 12 is less than or equal to the preset voltage of the power pin Vbus of the power supply interface 11, the switch circuit 15 is turned on, so that the power pin Vbus of the power supply interface 11 is connected to the power pin Vout of the power receiving interface 12. After the operational amplifier comparator circuit 14 determines that the divided voltage of the power pin Vout of the power receiving interface 12 is greater than the reference voltage and/or the power transfer control circuit 13 determines that the voltage of the power pin Vout of the power receiving interface 12 is greater than the preset voltage of the power pin Vbus of the power supply interface 11, the switch circuit 15 is turned off, so that the power pin Vbus of the power supply interface 11 is disconnected from the power pin Vout of the power receiving interface 12. The magnitudes of the reference voltage and the preset voltage of the power pin Vbus of the power supply interface 11 can be adjusted accordingly according to the actual anti-backflow requirements.

The operational amplifier comparator circuit 14 can respond quickly within nanoseconds and turn off the switch circuit 15 quickly, so the protection time of the operational amplifier comparator circuit 14 is at a nanosecond level such as 460 nanoseconds (ns). Due to timing issues, the time when the power transmission control circuit 13 turns off the switch circuit 15 lags slightly behind the time when the operational amplifier comparator circuit 14 turns off the switch circuit 15, and the protection time of the power transmission control circuit 13 is at a millisecond level such as 2 milliseconds (ms). Therefore, when the power pin Vout of the power receiving interface 12 of the charging cable 1 is suddenly applied with a voltage higher than the preset voltage (e.g., 20V) of the power pin Vbus of the power supply interface 11, the operational amplifier comparator circuit 14 turns off the switch circuit 15 first, and then the power transfer control circuit 13 turns off the switch circuit 15 to enhance the protection, thereby achieving a double protection effect.

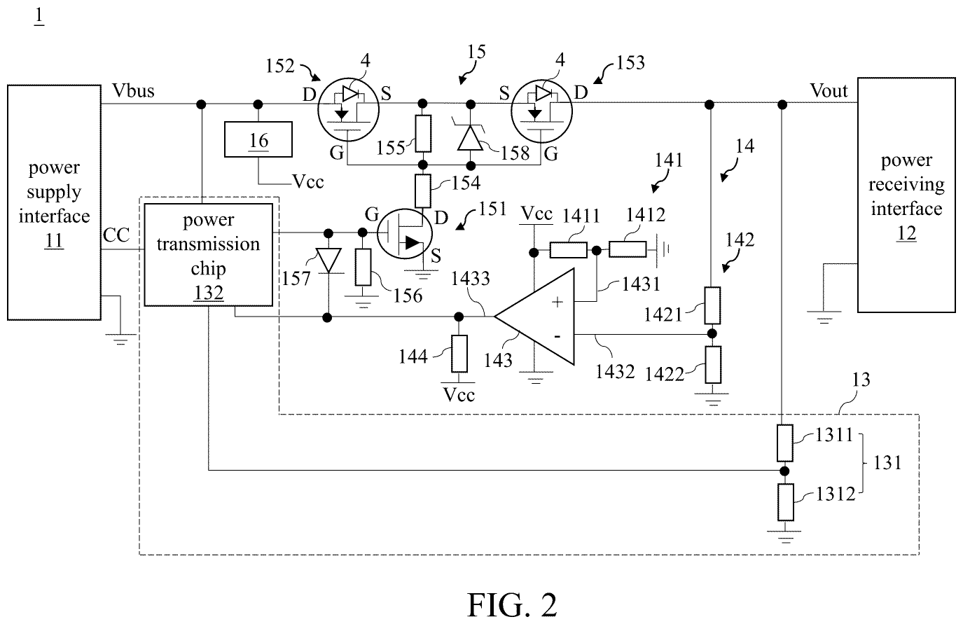

Please refer to FIG. 2, which a schematic structural diagram of a charging cable according to an embodiment of the present disclosure. As shown in FIG. 2, the power transfer control circuit 13 may comprise a sampling circuit 131 and a power transmission chip 132. The sampling circuit 131 may comprise a first resistor 1311 and a second resistor 1312. One end of the first resistor 1311 is connected to the power pin Vout of the power receiving interface 12, the other end of the first resistor 1311 is connected to one end of the second resistor 1312, and the other end of the second resistor 1312 is grounded. The power transmission chip 132 is connected to the power supply interface 11 and the other end of the first resistor 1311 (that is, the power transmission chip 132 is connected to the connection point between the first resistor 1311 and the second resistor 1312). The power transmission chip 132 may comprise an analog-to-digital converter (ADC), which is connected to the connection point between the first resistor 1311 and the second resistor 1312 through the general-purpose input/output (GPIO) pin of the power transmission chip 132. That is. the GPIO pin of the power transmission chip 132 is used for analog voltage sampling. When the power supply interface 11 is connected to the charging device and the power receiving interface 12 is connected to the DC power consumption device, the power transmission chip 132 controls the switch circuit 15 to be turned on after the power transmission chip 132 establishes a handshake connection with the charging device through the configuration channel pin CC of the power supply interface 11 successfully. When the power supply interface 11 is connected to the charging device, the power receiving interface 12 is connected to the DC power consumption device, and the power transmission chip 132 determines that the voltage of the power pin Vout of the power receiving interface 12 is less than or equal to the preset voltage of the power pin Vbus of the power supply interface 11 based on the voltage at the other end of the first resistor 1311 (i.e., the voltage at the voltage division point of the sampling circuit 131), the power transmission chip 132 keeps controlling the switch circuit 15 to be turned on. When the power supply interface 11 is connected to the charging device, the power receiving interface 12 is connected to the DC power consumption device, and the power transmission chip 132 determines that the voltage of the power pin Vout of the power receiving interface 12 is greater than the preset voltage of the power pin Vbus of the power supply interface 11 based on the voltage at the other end of the first resistor 1311, the power transmission chip 132 control the switch circuit 15 to be turned off.

In an example, the preset voltage of the power pin Vbus of the power supply interface 11 is 20 volts, the resistance value of the first resistor 1311 may be 100 kilo-ohms, and the resistance value of the second resistor 1312 may be 4.99 kilo-ohms. When the power transmission chip 132 determines that the voltage of the voltage division point of the sampling circuit 131 is greater than 0.95 volts, it means that it is determined that the voltage of the power pin Vout of the power receiving interface 12 is greater than the preset voltage of the power pin Vbus of the power supply interface 11, and the power transmission chip 132 outputs an enable signal with a low level to the switch circuit 15, thereby controlling the switch circuit 15 to be turned off. When the power transmission chip 132 determines that the voltage of the voltage division point of the sampling circuit 131 is less than or equal to 0.95 volts, it means that it is determined that the voltage of the power pin Vout of the power receiving interface 12 is less than or equal to the preset voltage of the power pin Vbus of the power supply interface 11, and the power transmission chip 132 outputs an enable signal with a high level to the switch circuit 15, thereby controlling the switch circuit 15 to be turned on. The time for the enable signal output by the power transmission chip 132 to switch from the high level to the low level may be, but is not limited to, 2 milliseconds.

In one embodiment, the operational amplifier comparator circuit 14 may comprise a first voltage division circuit 141, a second voltage division circuit 142 and a comparator 143. One end of the first voltage division circuit 141 is connected to a power supply voltage Vcc, the other end of the first voltage division circuit 141 is grounded, and a voltage division point of the first voltage division circuit 141 generates the reference voltage based on the power supply voltage Vcc. One end of the second voltage division circuit 142 is connected to the power pin Vout of the power receiving interface 12, the other end of the second voltage division circuit 142 is grounded, and a voltage of a voltage division point of the second voltage division circuit 142 is the divided voltage of the power pin Vout of the power receiving interface 12. The comparator 143 comprise a positive input terminal 1431, a negative input terminal 1432 and an output terminal 1433, wherein the positive input terminal 1431 is connected to the voltage division point of the first voltage dividing circuit 141, the negative input terminal 1432 is connected to the voltage division point of the second voltage dividing circuit 142, and the output terminal 1433 is connected to the switch circuit 15. The comparator 143 is configured to compare the voltage of the voltage division point of the second voltage dividing circuit 142 with the reference voltage (i.e., the voltage of the voltage division point of the first voltage dividing circuit 141). After the operational amplifier comparator circuit 14 determines that the voltage of the voltage division point of the second voltage dividing circuit 142 is greater than the reference voltage, the switch circuit 15 is turned off. After the operational amplifier comparator circuit 14 determines that the voltage of the voltage division point of the second voltage dividing circuit 142 is less than or equal to the reference voltage, the switch circuit 15 is turned on. The response speed of the comparator 143 is extremely high (e.g., 460 ns). After the comparator 143 determines that the voltage of the voltage division point of the second voltage dividing circuit 142 is greater than the reference voltage, the signal output by the output terminal 1433 of the comparator 143 transits from the original high level to the low level quickly.

In one embodiment, the first voltage division circuit 141 may comprise a fifth resistor 1411 and a sixth resistor 1412, wherein one end of the fifth resistor 1411 is connected to the power supply voltage Vcc, the other end of the fifth resistor 1411 is connected to one end of the sixth resistor 1412, and the other end of the sixth resistor 1412 is grounded. The second voltage division circuit 142 may comprise a seventh resistor 1421 and an eighth resistor 1422, wherein one end of the seventh resistor 1421 is connected to the power pin Vout of the power receiving interface 12, the other end of the seventh resistor 1421 is connected to one end of the eighth resistor 1422, and the other end of the eighth resistor 1422 is grounded.

In an example, the power supply voltage Vcc may be 3.3 volts, the resistance value of the fifth resistor 1411 may be 100 kilo-ohms, and the resistance value of the sixth resistor 1412 may be 49.9 kilo-ohms, so that the reference voltage may be approximately 1.1 volts. The preset voltage of the power supply pin Vbus of the power supply interface 11 may be 20 volts, the resistance value of the seventh resistor 1421 may be 100 kilo-ohms, and the resistance value of the eighth resistor 1422 may be 5.76 kilo-ohms, so that when the voltage at the voltage division point of the second voltage dividing circuit 142 is approximately less than or equal to 1.1 volts, the output terminal 1433 outputs a high-level signal to the switch circuit 15, thereby controlling the switch circuit 15 to be turned on; when the voltage at the voltage division point of the second voltage dividing circuit 142 is approximately greater than 1.1 volts, the output terminal 1433 outputs a low-level signal to the switch circuit 15, thereby controlling the switch circuit 15 to be turned off.

In one embodiment, the operational amplifier comparator circuit 14 may further comprise a pull-up resistor 144, wherein one end of the pull-up resistor 144 is connected to the output terminal 1433, and the other end of the pull-up resistor 144 is connected to the power supply voltage Vcc. The pull-up resistor 144 is configured to make the output terminal 1433 output a high-level voltage by default, so that the switch circuit 15 is turned on by default.

In one embodiment, the switch circuit 15 comprise an NMOS transistor 151, a first PMOS transistor 152, a second PMOS transistor 153, a third resistor 154, a fourth resistor 155 and a first pull-down resistor 156. The source S of the NMOS transistor 151 is grounded, the gate G of the NMOS transistor 151 is connected to the power transfer control circuit 13 and one end of the first pull-down resistor 156, the other end of the first pull-down resistor 156 is grounded, the drain D of the NMOS transistor 151 is connected to one end of the third resistor 154, the other end of the third resistor 154 is connected to the gate G of the first PMOS transistor 152, the gate G of the second PMOS transistor 153 and one end of the fourth resistor 155, the source S of the first PMOS transistor 152 is connected to the source S of the second PMOS transistor 153 and the other end of the fourth resistor 155, the drain D of the first PMOS transistor 152 is connected to the power pin Vbus of the power supply interface 11, and the drain D of the second PMOS transistor 153 is connected to the power pin Vout of the power receiving interface 12.

When the power supply interface 11 is connected to the charging device and the power receiving interface 12 is not connected to the DC power consumption device, or the power supply interface 11 is not connected to the charging device and the power receiving interface 12 is connected to the DC power consumption device, the NMOS transistor 151 is grounded via the first pull-down resistor 156 and is in a cut-off state. At this time, the voltages at both ends of the fourth resistor 155 are equal, and the gate-source voltage difference Vgs of the first PMOS transistor 152 and the second PMOS transistor 153 are zero volt, so that the first PMOS transistor 152 and the second PMOS transistor 153 are in a cut-off state.

When the power supply interface 11 is connected to the charging device and the power receiving interface 12 is connected to the DC power consumption device, after the power transfer control circuit 13 successfully handshakes with the charging device, the power transfer control circuit 13 outputs an enable signal with a high level to the gate G of the NMOS transistor 151 to make the NMOS transistor 151, the first PMOS transistor 152 and the second PMOS transistor 153 conduct, so that the power pin Vbus of the power supply interface 11 is connected to the power pin Vout of the power receiving interface 12. If the power transfer control circuit 13 determines that the voltage of the power pin Vout of the power receiving interface 12 is less than or equal to the preset voltage of the power pin Vbus of the power supply interface 11, the power transfer control circuit 13 outputs the enable signal with a high level to the gate G of the NMOS transistor 151 to make the NMOS transistor 151, the first PMOS transistor 152 and the second PMOS transistor 153 remain conducting, so that the power pin Vbus of the power supply interface 11 and the power pin Vout of the power receiving interface 12 are kept in electrical connection. If the power transfer control circuit 13 determines that the voltage of the power pin Vout of the power receiving interface 12 is greater than the preset voltage of the power pin Vbus of the power supply interface 11, the power transfer control circuit 13 outputs an enable signal with a low level to the gate G of the NMOS transistor 151 to make the NMOS transistor 151, the first PMOS transistor 152 and the second PMOS transistor 153 cut off, so that the power pin Vbus of the power supply interface 11 is disconnected from the power pin Vout of the power receiving interface 12. If the operational amplifier comparator circuit 14 determines that the divided voltage of the power pin Vout of the power receiving interface 12 is greater than the reference voltage, the operational amplifier comparator circuit 14 outputs a control signal with a low level to the gate G of the NMOS transistor 151 to make the NMOS transistor 151, the first PMOS transistor 152 and the second PMOS transistor 153 cut off, so that the power pin Vbus of the power supply interface 11 is disconnected from the power pin Vout of the power receiving interface 12.

In one embodiment, the switch circuit 15 may further comprise a first diode 157, the positive electrode of the first diode 157 is connected to the gate G of the NMOS transistor 151, and the negative electrode of the first diode 157 is connected to the operational amplifier comparator circuit 14. Specifically, when the operational amplifier comparator circuit 14 determines that the divided voltage of the power pin Vout of the power receiving interface 12 is greater than the reference voltage, the operational amplifier comparator circuit 14 outputs a control signal with a low level, and then the level of the gate G of the NMOS transistor 151 is lowered through the first diode 157 to make the NMOS transistor 151, the first PMOS transistor 152 and the second PMOS transistor 153 cut off, so that the power pin Vbus of the power supply interface 11 is disconnected from the power pin Vout of the power receiving interface 12.

In one embodiment, the switch circuit 15 may further comprise a Zener diode 158, wherein the positive electrode of the Zener diode 158 is connected to the gate G of the first PMOS transistor 152 and the gate G of the second PMOS transistor 153, and the negative electrode of the Zener diode 158 is connected to the source S of the first PMOS transistor 152 and the source S of the second PMOS transistor 153. Specifically, since the switching speed of the NMOS transistor 151 is extremely high, in order to prevent the surge voltage from exceeding the gate-source voltage difference Vgs of the first PMOS transistor 152 and the second PMOS transistor 153 and damaging the first PMOS transistor 152 and the second PMOS transistor 153, the Zener diode 158 is disposed between the gate G and the source S of the first PMOS transistor 152 and the second PMOS transistor 153. The Zener diode 158 can clamp the voltage on the fourth resistor 155 below the gate-source voltage difference Vgs of the first PMOS transistor 152 and the second PMOS transistor 153. The regulator voltage of the Zener diode 158 must be lower than the gate-source voltage difference Vgs of the first PMOS transistor 152 and the second PMOS transistor 153.

In one embodiment, each of the first PMOS transistor 152 and the second PMOS transistor 153 is provided with a parasitic diode 4. The positive electrode of the parasitic diode 4 of the first PMOS transistor 152 is connected to the drain D of the first PMOS transistor 152, and the negative electrode of the parasitic diode 4 of the first PMOS transistor 152 is connected to the source S of the first PMOS transistor 152. The positive electrode of the parasitic diode 4 of the second PMOS transistor 153 is connected to the drain D of the second PMOS transistor 153, and the negative electrode of the parasitic diode 4 of the second PMOS transistor 153 is connected to the source S of the second PMOS transistor 153.

In one embodiment, the charging cable 1 may further comprise a low-dropout regulator 16, the low-dropout regulator 16 is connected to the power pin Vbus of the power supply interface 11 and the power voltage Vcc, and the low-dropout regulator 16 is configured to convert the power voltage Vcc into the preset voltage of the power pin Vbus of the power supply interface 11, and provide the preset voltage to the power pin Vbus of the power supply interface 11.

In one embodiment, when the power supply interface 11 is not connected to the charging device, the power receiving interface 12 is connected to the DC power consumption device, and the voltage of the power pin Vout of the power receiving interface 12 is greater than the preset voltage of the power pin Vbus of the power supply interface 11, the power transfer control circuit 13 and the operational amplifier comparator circuit 14 do not work, and the switch circuit 15 is turned off based on pulling down of the first pull-down resistor 156, so that the power pin Vbus of the power supply interface 11 is disconnected from the power pin Vout of the power receiving interface 12. Specifically, when the power supply interface 11 is not connected to the charging device, the power receiving interface 12 is connected to the DC power consumption device, and the voltage of the power pin Vout of the power receiving interface 12 is greater than the preset voltage of the power pin Vbus of the power supply interface 11, the power transfer control circuit 13 and the operational amplifier comparator circuit 14 do not work (at this time, the power supply voltage Vcc is zero volt), and the gate G of the NMOS transistor 151 is at a low level, and the NMOS transistor 151 is in a cut-off state based on the setting of the first pull-down resistor 156. At this time, the voltages at both ends of the fourth resistor 155 are equal, and the first PMOS transistor 152 and the second PMOS transistor 153 are in a cut-off state, so that the power pin Vbus of the power supply interface 11 is disconnected from the power pin Vout of the power receiving interface 12. At this moment, if the power supply interface 11 is connected to the charging device 2, after the power transfer control circuit 13 determines that the voltage of the power pin Vout of the power receiving interface 12 is greater than the preset voltage of the power pin Vbus of the power supply interface 11, the power transfer control circuit 13 outputs a enable signal with a low level to the gate G of the NMOS transistor 151, thereby controlling the switch circuit 15 to be turned off (that is, the NMOS transistor 151, the first PMOS transistor 152 and the second PMOS transistor 153 remain cut off), and after the operational amplifier comparator circuit 14 determines that the divided voltage of the power pin Vout of the power receiving interface 12 is greater than the reference voltage, the operational amplifier comparator circuit 14 outputs a control signal with a low level to the gate G of the NMOS transistor 151, thereby controlling the switch circuit 15 to be turned off (that is, the NMOS transistor 151, the first PMOS transistor 152 and the second PMOS transistor 153 remain cut off).

In summary, when the power supply interface is connected to the charging device and the power receiving interface is connected to the DC power consumption device, if the power pin of the power receiving interface is suddenly applied with a voltage higher than the preset voltage of the power pin of the power supply interface, the operational amplifier comparator circuit determines that the divided voltage of the power pin of the power receiving interface is greater than the reference voltage and the power transfer control circuit determines that the voltage of the power pin of the power receiving interface is greater than the preset voltage of the power pin of the power supply interface, and the switch circuit is turned off, so that the power pin of the power supply interface is disconnected from the power pin of the power receiving interface, and the anti-backflow protection function is realized. The operational amplifier comparator circuit can respond quickly within nanoseconds and turn off the switch circuit quickly, so the protection time of the operational amplifier comparator circuit is at a nanosecond level. However, due to timing issues, the protection time of the power transmission control circuit lags slightly behind that of the operational amplifier comparator circuit, and the protection time of the power transmission control circuit is at a millisecond level. Therefore, when the power pin of the power receiving interface of the charging cable of the embodiment of the present disclosure is suddenly applied with the voltage higher than the preset voltage of the power pin of the power supply interface, the operational amplifier comparator circuit turns off the switch circuit first, and then the power transfer control circuit turns off the switch circuit to enhance the protection, thereby achieving a double protection effect.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A charging cable, comprising:
a power supply interface selectively connected to a charging device;
a power receiving interface selectively connected to a DC power consumption device;
a power transfer control circuit connected to the power supply interface and the power receiving interface and configured to establish a handshake connection with the charging device when the power supply interface is connected to the charging device and the power receiving interface is connected to the DC power consumption device, and monitor a voltage of a power pin of the power receiving interface;
an operational amplifier comparator circuit connected to the power pin of the power receiving interface and the switch circuit and configured to compare a divided voltage of the power pin of the power receiving interface with a reference voltage when the power supply interface is connected to the charging device and the power receiving interface is connected to the DC power consumption device; and
a switch circuit connected to the power transfer control circuit, the operational amplifier comparator circuit, a power pin of the power supply interface and the power pin of the power receiving interface, and configured to be turned on to connect the power pin of the power supply interface to the power pin of the power receiving interface after the power transfer control circuit successfully handshakes with the charging device and/or determines that the voltage of the power pin of the power receiving interface is less than or equal to a preset voltage of the power pin of the power supply interface, and to be turned off to disconnect the power pin of the power supply interface from the power pin of the power receiving interface after the operational amplifier comparator circuit determines that the divided voltage of the power pin of the power receiving interface is greater than the reference voltage and/or the power transfer control circuit determines that the voltage of the power pin of the power receiving interface is greater than the preset voltage.

2. The charging cable according to claim 1, wherein the power transfer control circuit comprises:
a sampling circuit comprising a first resistor and a second resistor, wherein one end of the first resistor is connected to the power pin of the power receiving interface, the other end of the first resistor is connected to one end of the second resistor, and the other end of the second resistor is grounded; and
a power transmission chip connected to the power supply interface and the other end of the first resistor, and configured to control the switch circuit to be turned on after the power transmission chip establishes a handshake connection with the charging device through the power supply interface successfully in a condition that the power supply interface is connected to the charging device and the power receiving interface is connected to the DC power consumption device, and to keep controlling the switch circuit to be turned on when the power transmission chip determines that the voltage of the power pin of the power receiving interface is less than or equal to the preset voltage based on a voltage of the other end of the first resistor, and to control the switch circuit to be turned off when the power transmission chip determines that the voltage of the power pin of the power receiving interface is greater than the preset voltage based on the voltage of the other end of the first resistor.

3. The charging cable according to claim 1, wherein the operational amplifier comparator circuit comprises:
a first voltage division circuit, wherein one end of the first voltage division circuit is connected to a power supply voltage, the other end of the first voltage division circuit is grounded, and a voltage division point of the first voltage division circuit generates the reference voltage based on the power supply voltage;
a second voltage division circuit, wherein one end of the second voltage division circuit is connected to the power pin of the power receiving interface, the other end of the second voltage division circuit is grounded, and a voltage of a voltage division point of the second voltage division circuit is the divided voltage of the power pin of the power receiving interface; and
a comparator comprising a positive input terminal, a negative input terminal and an output terminal, wherein the positive input terminal is connected to the voltage division point of the first voltage division circuit, the negative input terminal is connected to the voltage division point of the second voltage division circuit, the output terminal is connected to the switch circuit, and the comparator is configured to compare the voltage of the voltage division point of the second voltage division circuit with the reference voltage.

4. The charging cable according to claim 3, wherein the operational amplifier comparator circuit further comprises a pull-up resistor, one end of the pull-up resistor is connected to the output terminal, the other end of the pull-up resistor is connected to the power supply voltage, and the pull-up resistor is configured to make the output terminal output a high-level voltage by default.

5. The charging cable according to claim 1, wherein the switch circuit comprises an NMOS transistor, a first PMOS transistor, a second PMOS transistor, a third resistor, a fourth resistor and a first pull-down resistor, a source of the NMOS transistor is grounded, a gate of the NMOS transistor is connected to the power transfer control circuit and one end of the first pull-down resistor, the other end of the first pull-down resistor is grounded, a drain of the NMOS transistor is connected to one end of the third resistor, the other end of the third resistor is connected to a gate of the first PMOS transistor, a gate of the second PMOS transistor and one end of the fourth resistor, a source of the first PMOS transistor is connected to a source of the second PMOS transistor and the other end of the fourth resistor, a drain of the first PMOS transistor is connected to the power pin of the power supply interface, and a drain of the second PMOS transistor is connected to the power pin of the power receiving interface; when the power transfer control circuit successfully handshakes with the charging device and/or determines that the voltage of the power pin of the power receiving interface is less than or equal to the preset voltage, the power transfer control circuit outputs an enabling signal with a high level to the gate of the NMOS transistor, to make the NMOS transistor, the first PMOS transistor and the second PMOS transistor conduct, so that the power pin of the power supply interface is connected to the power pin of the power receiving interface; when the operational amplifier comparator circuit determines that the divided voltage of the power pin of the power receiving interface is greater than the reference voltage, the operational amplifier comparator circuit outputs a control signal with a low level to the gate of the NMOS transistor, to make the NMOS transistor, the first PMOS transistor and the second PMOS transistor cut off, so that the power pin of the power supply interface is disconnected from the power pin of the power receiving interface; when the power transfer control circuit determines that the voltage of the power pin of the power receiving interface is greater than the preset voltage, the power transfer control circuit outputs an enable signal with a low level to the gate of the NMOS transistor, to make the NMOS transistor, the first PMOS transistor and the second PMOS transistor cut off, so that the power pin of the power supply interface is disconnected from the power pin of the power receiving interface.

6. The charging cable according to claim 5, wherein the switch circuit further comprises a first diode, a positive electrode of the first diode is connected to the gate of the NMOS transistor, and a negative electrode of the first diode is connected to an output terminal of the operational amplifier comparator circuit.

7. The charging cable according to claim 5, wherein the switch circuit further comprises a Zener diode, a positive electrode of the Zener diode is connected to the gate of the first PMOS transistor and the gate of the second PMOS transistor, and a negative electrode of the Zener diode is connected to the source of the first PMOS transistor and the source of the second PMOS transistor.

8. The charging cable according to claim 5, wherein each of the first PMOS transistor and the second PMOS transistor is provided with a parasitic diode; a positive electrode of the parasitic diode of the first PMOS transistor is connected to the drain of the first PMOS transistor, and a negative electrode of the parasitic diode of the first PMOS transistor is connected to the source of the first PMOS transistor; a positive electrode of the parasitic diode of the second PMOS transistor is connected to the drain of the second PMOS transistor, and a negative electrode of the parasitic diode of the second PMOS transistor is connected to the source of the second PMOS transistor.

9. The charging cable according to claim 5, wherein when the power supply interface is not connected to the charging device, the power receiving interface is connected to the DC power consumption device, and the voltage of the power pin of the power receiving interface is greater than the preset voltage of the power pin of the power supply interface, the power transfer control circuit and the operational amplifier comparator circuit do not work, and the switch circuit is turned off based on pulling down of the first pull-down resistor, so that the power pin of the power supply interface is disconnected from the power pin of the power receiving interface.

10. The charging cable according to claim 1, further comprising a low-dropout regulator, wherein the low-dropout regulator is connected to the power pin of the power supply interface and a power supply voltage, and the low-dropout regulator is configured to convert the power supply voltage to the preset voltage, and provide the preset voltage to the power pin of the power supply interface.

11. The charging cable according to claim 1, wherein the power supply interface is a USB Type-C interface, the power receiving interface is a DC connector, and the power pin of the power receiving interface is a positive terminal of the DC connector.
